(19) United States
(12) Patent Application Publication
(10) Pub. No.: US 2024/0389073 A1
(43) Pub. Date: Nov. 21, 2024

(54) DIFFERENTIAL CHANNEL STATE INFORMATION REPORTING FOR DYNAMIC SPATIAL AND POWER ADAPTATION

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/428,949

(22) Filed: Jan. 31, 2024

Related U.S. Application Data
(60) Provisional application No. 63/502,293, filed on May 15, 2023.

(51) Int. Cl. H04W 72/02; H04B 7/06; H04W 72/542

(52) U.S. Cl. CPC H04W 72/02; H04B 7/0626; H04W 72/542

(57) ABSTRACT

Methods, systems, and devices for wireless communications are described. A user equipment (UE) may receive from a network entity a set of resources in accordance with a channel state information (CSI) reporting procedure. The UE may select a first resource from the set of resources as a baseline resource on a criteria for the set of resources. For example, the criteria may be based on a respective channel quality indicator (CQI), a rank indicator (RI), a resource ID value, a power offset value, or a combination thereof associated with each resource. The UE may transmit in accordance with the CSI reporting procedure, a CSI report that includes a baseline indicator associated with the baseline resource and respective differential indicators for each other resource of the set of resources. In some examples, the respective differential indicators may be relative to the baseline indicator.

### CROSS REFERENCE

The present Application for patent claims the benefit of U.S. Provisional Patent Application No. 63/502,293 by ABOTABL et al., entitled “DIFFERENTIAL CHANNEL STATE INFORMATION REPORTING FOR DYNAMIC SPATIAL AND POWER ADAPTATION,” filed May 15, 2023, assigned to the assignee hereof, and expressly incorporated by reference herein.

### FIELD OF TECHNOLOGY

The following relates to wireless communications, including differential channel state information (CSI) reporting for dynamic spatial and power adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support differential channel state information (CSI) reporting for dynamic spatial and power adaptation. For example, the described techniques provide for reducing a quantity of bits in a report including CSI information for multiple resources. For example, a user equipment (UE) may report a full set of CSI corresponding to one resource as a baseline CSI and report CSI information for one or more other resources as a differential CSI relative to the baseline CSI. The UE may select a resource for the baseline CSI of a given CSI report according to the techniques described herein. For example, as part of a CSI reporting procedure, the UE may receive or otherwise be assigned a set of CSI resources (e.g., each associated with a respective CSI reference signal (CSI-RS)). Each received resource may be associated with a respective channel quality indicator (CQI), a rank indicator (RI), a resource ID value, a power offset value, or a combination thereof. In some examples, the UE may select the baseline resource as the resource associated with the highest CQI, highest RI, or both. In some examples, the UE may select a baseline resource as the resource associated with the highest or lowest resource ID value. In some examples, the UE may select a baseline resource as the resource associated with the highest or lowest power offset value. As such, the UE may transmit a CSI report including the CSI associated with the baseline resource as the baseline CSI and the CSIs for the non-baseline resources as differential CSIs relative to the baseline CSI.

A method for wireless communications is described. The method may include receiving a set of resources in accordance with a CSI reporting procedure, selecting a first resource from the set of resources as a baseline resource based on a criteria for the set of resources, and transmitting, in accordance with the CSI reporting procedure, a CSI report including an baseline indicator associated with the baseline resource and respective differential indicators for each other resource of the set of resources, where the respective differential indicators are relative to the baseline indicator.

A UE for wireless communications is described. The UE may include one or more memories storing processor executable code, and one or more processors coupled with the one or more memories. The one or more processors may be operable to execute the code to cause the UE to receive a set of resources in accordance with a CSI reporting procedure, select a first resource from the set of resources as a baseline resource based on a criteria for the set of resources, and transmit, in accordance with the CSI reporting procedure, a CSI report including an baseline indicator associated with the baseline resource and respective differential indicators for each other resource of the set of resources, where the respective differential indicators are relative to the baseline indicator.

Another UE for wireless communications is described. The UE may include means for receiving a set of resources in accordance with a CSI reporting procedure, means for selecting a first resource from the set of resources as a baseline resource based on a criteria for the set of resources, and means for transmitting, in accordance with the CSI reporting procedure, a CSI report including an baseline indicator associated with the baseline resource and respective differential indicators for each other resource of the set of resources, where the respective differential indicators are relative to the baseline indicator.

A non-transitory computer-readable medium storing code for wireless communications is described. The code may include instructions executable by one or more processors to receive a set of resources in accordance with a CSI reporting procedure, select a first resource from the set of resources as a baseline resource based on a criteria for the set of resources, and transmit, in accordance with the CSI reporting procedure, a CSI report including an baseline indicator associated with the baseline resource and respective differential indicators for each other resource of the set of resources, where the respective differential indicators are relative to the baseline indicator.

In some examples of the method, UEs, and non-transitory computer-readable medium described herein, the criteria for the set of resources may be a CQI value and the method, UEs, and non-transitory computer-readable medium may include further operations, features, means, or instructions for measuring a respective CQI for each resource of the set of resources, where selecting the first resource as the baseline resource may be based on the first resource being associated with a highest CQI value out of the set of resources.

In some examples of the method, UEs, and non-transitory computer-readable medium described herein, the first resource and one or more other resources of the set of resources each may have the highest CQI value out of the set of resources and the method, UEs, and non-transitory computer-readable medium may include further operations, features, means, or instructions for receiving a respective RI for each resource of the set of resources, where selecting the first resource as the baseline resource may be further based on the first resource being associated with a highest RI value out of the set of resources.

In some examples of the method, UEs, and non-transitory computer-readable medium described herein, the criteria for the set of resources may be a RI value and the method, UEs, and non-transitory computer-readable medium may include further operations, features, means, or instructions for receiving a respective RI for each resource of the set of resources, where selecting the first resource as the baseline resource may be based on the first resource being associated with a highest RI value out of the set of resources.

In some examples of the method, UEs, and non-transitory computer-readable medium described herein, the first resource and one or more other resources of the set of resources each may have the highest RI value out of the set of resources and the method, UEs, and non-transitory computer-readable medium may include further operations, features, means, or instructions for measuring a respective CQI for each resource of the set of resources, where selecting the first resource as the baseline resource may be further based on the first resource being associated with a highest CQI value out of the set of resources.

In some examples of the method, UEs, and non-transitory computer-readable medium described herein, the baseline resource corresponds to a codebook that may have a rank greater than four, the codebook being associated with a first codeword associated with a first indicator and a second codeword associated with a second indicator.

In some examples of the method, UEs, and non-transitory computer-readable medium described herein, selecting the first resource as the baseline resource may include operations, features, means, or instructions for selecting the first indicator as the baseline indicator based on the first indicator being associated with the first codeword and based on the first resource satisfying the criteria for the set of resources.

In some examples of the method, UEs, and non-transitory computer-readable medium described herein, selecting the first resource as the baseline resource may include operations, features, means, or instructions for selecting the first indicator or the second indicator as the baseline indicator based on irrespective of association with the first codeword and the second codeword and based on the first resource satisfying the criteria for the set of resources and transmitting, as part of the CSI report, an indication of whether the UE selected the first indicator or the second indicator as the baseline indicator.

In some examples of the method, UEs, and non-transitory computer-readable medium described herein, each resource of the set of resources may be associated with a respective power offset value, and the criteria for the set of resources may be based on a power offset value.

Some examples of the method, UEs, and non-transitory computer-readable medium described herein may further include operations, features, means, or instructions for selecting the first resource as the baseline resource may be further based on the first resource being associated with a highest power offset value out of the set of resources.

Some examples of the method, UEs, and non-transitory computer-readable medium described herein may further include operations, features, means, or instructions for selecting the first resource as the baseline resource may be further based on the first resource being associated with a lowest power offset value out of the set of resources.

Some examples of the method, UEs, and non-transitory computer-readable medium described herein may further include operations, features, means, or instructions for receiving control signaling including an indication of the criteria for the set of resources to use for selecting the baseline resource.

In some examples of the method, UEs, and non-transitory computer-readable medium described herein, the criteria for the set of resources to use for selecting the baseline resource may be stored at the UE.

Some examples of the method, UEs, and non-transitory computer-readable medium described herein may further include operations, features, means, or instructions for transmitting, as part of the CSI report, an indication of the criteria for the set of resources used for selecting the baseline resource.

In some examples of the method, UEs, and non-transitory computer-readable medium described herein, the baseline indicator may be a CQI and the respective differential indicators may be each a respective differential CQI, the baseline indicator may be a RI and the respective differential indicators may be each a respective differential RI, or the baseline indicator may be a pre-coding matrix indicator (PMI) and the respective differential indicators may be each a respective differential PMI.

A method for wireless communications is described. The method may include transmitting a set of resources in accordance with a CSI reporting procedure for a dynamic antenna configuration of the network entity and receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

A network entity for wireless communications is described. The network entity may include one or more memories storing processor executable code, and one or more processors coupled with the one or more memories. The one or more processors may be operable to execute the code to cause the network entity to transmit a set of resources in accordance with a CSI reporting procedure for a dynamic antenna configuration of the network entity and receive, in accordance with the CSI reporting procedure, a CSI report including a baseline indicator associated with a baseline resource of the set of resources and respective differential indicators for each other resource of the set of resources, where the respective differential indicators are relative to the baseline indicator.

Another network entity for wireless communications is described. The network entity may include means for transmitting a set of resources in accordance with a CSI reporting procedure for a dynamic antenna configuration of the network entity and means for receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

A non-transitory computer-readable medium storing code for wireless communications is described. The code may include instructions executable by a one or more processors to transmit a set of resources in accordance with a CSI reporting procedure for a dynamic antenna configuration of the network entity and receive, in accordance with the CSI reporting procedure, a CSI report including a baseline indicator associated with a baseline resource of the set of resources and respective differential indicators for each other resource of the set of resources, where the respective differential indicators are relative to the baseline indicator.

Some examples of the method, network entities, and non-transitory computer-readable medium described herein may further include operations, features, means, or instructions for transmitting control signaling including an indication of a criteria for the set of resources for a UE to use selecting the baseline resource.

In some examples of the method, network entities, and non-transitory computer-readable medium described herein, the criteria may include operations, features, means, or instructions for indicating for the UE to select the baseline resource as a resource from the set of resources being associated with a highest CQI value out of the set of resources, a highest RI value out of the set of resources, or both.

In some examples of the method, network entities, and non-transitory computer-readable medium described herein, the criteria may include operations, features, means, or instructions for indicating for the UE to select the baseline resource as a resource from the set of resources being associated with a highest or lowest resource ID value out of the set of resources.

In some examples of the method, network entities, and non-transitory computer-readable medium described herein, the criteria may include operations, features, means, or instructions for indicating for the UE to select the baseline resource as a resource from the set of resources being associated with a highest or lowest power offset value out of the set of resources.

Some examples of the method, network entities, and non-transitory computer-readable medium described herein may further include operations, features, means, or instructions for receiving, as part of the CSI report, an indication of the criteria for the set of resources used by the UE for selecting the baseline resource.

In some examples of the method, network entities, and non-transitory computer-readable medium described herein, the baseline resource corresponds to a codebook that may have a rank greater than four and the method, network entities, and non-transitory computer-readable medium may include further operations, features, means, or instructions for receiving, as part of the CSI report, an indication of whether the first indicator or the second indicator may be the baseline indicator.

In some examples of the method, network entities, and non-transitory computer-readable medium described herein, the baseline indicator may be a CQI and the respective differential indicators may be each a respective differential CQI, the baseline indicator may be a RI and the respective differential indicators may be each a respective differential RI, or the baseline indicator may be a PMI and the respective differential indicators may be each a respective differential PMI.

### BRIEF DESCRIPTION OF THE DRAWINGS

FIG. 1 shows an example of a wireless communications system that supports differential channel state information (CSI) reporting for dynamic spatial and power adaptation in accordance with one or more aspects of the present disclosure.

FIG. 2 shows an example of a wireless communications system that supports differential CSI reporting for dynamic spatial and power adaptation in accordance with one or more aspects of the present disclosure.

FIG. 3 shows an example of a process flow that supports differential CSI reporting for dynamic spatial and power adaptation in accordance with one or more aspects of the present disclosure.

FIGS. 4 and 5 show block diagrams of devices that support differential CSI reporting for dynamic spatial and power adaptation in accordance with one or more aspects of the present disclosure.

FIG. 6 shows a block diagram of a communications manager that supports differential CSI reporting for dynamic spatial and power adaptation in accordance with one or more aspects of the present disclosure.

FIG. 7 shows a diagram of a system including a device that supports differential CSI reporting for dynamic spatial and power adaptation in accordance with one or more aspects of the present disclosure.

FIGS. 8 and 9 show block diagrams of devices that support differential CSI reporting for dynamic spatial and power adaptation in accordance with one or more aspects of the present disclosure.

FIG. 10 shows a block diagram of a communications manager that supports differential CSI reporting for dynamic spatial and power adaptation in accordance with one or more aspects of the present disclosure.

FIG. 11 shows a diagram of a system including a device that supports differential CSI reporting for dynamic spatial and power adaptation in accordance with one or more aspects of the present disclosure.

FIGS. 12 through 15 show flowcharts illustrating methods that support differential CSI reporting for dynamic spatial and power adaptation in accordance with one or more aspects of the present disclosure.

### DETAILED DESCRIPTION

In some examples, a network may reduce energy consumption associated with wireless communications by operating in accordance with antenna spatial and power adaptation. For example, a network entity may include a set of antennas used to communicate data traffic with one or more wireless devices (e.g., user equipment (UEs)). As such, the network entity may dynamically update an antenna port configuration used for communication with a UE based on a quantity of data traffic. For instance, in accordance with spatial domain (SD) adaptation, the network entity may dynamically change the quantity or configuration of antenna ports in use. In accordance with power domain (PD) adaptation, the network entity may dynamically change the transmission power of the antennas. Both SD and PD adaptation may result in power reduction by dynamically configuring antenna settings based on data traffic. As such, the UE may be configured to transmit channel state information (CSI) for each dynamic antenna configuration (e.g., multiple CSIs in a single CSI report). However, as the quantity of CSIs in a CSI report increases, the quantity of bits in the CSI report may increase. As such, dynamic antenna adaptation may increase a quantity of CSI resources, CSI reports, and CSI configuration to support multiple spatial patterns and power values.

To reduce the quantity of bits in the CSI report, the UE may select one CSI in the CSI report as a baseline CSI and transmit the other CSIs as a differential CSI relative to the selected CSI. The UE may determine the baseline CSI for a given CSI report according to the techniques described herein. For example, as part of a CSI reporting procedure, the UE may receive or otherwise be assigned a set of resources (e.g., each associated with a respective CSI reference signal (CSI-RS)) to monitor for CSI measurements. Each resource may be associated with a respective channel quality indicator (CQI), a rank indicator (RI), a resource ID value, a power offset value, or a combination thereof. In some examples, the UE may select the baseline resource as the resource associated with the highest CQI, highest RI, or both. In some examples, the UE may select a baseline resource as the resource associated with the highest or lowest resource ID value. In some examples, the UE may select a baseline resource as the resource associated with the highest or lowest power offset value. As such, the CSI associated with the baseline resource may be the baseline CSI and the other CSIs may be differential CSIs relative to the baseline CSI. By transmitting a CSI report including differential CSIs, the UE may reduce the quantity of bits included in the CSI report, which may reduce overhead associated with performing CSI reporting procedures with the network entity.

Aspects of the disclosure are initially described in the context of wireless communications systems and a process flow. Aspects of the disclosure are further illustrated by and described with reference to apparatus diagrams, system diagrams, and flowcharts that relate to differential CSI reporting for dynamic spatial and power adaptation.

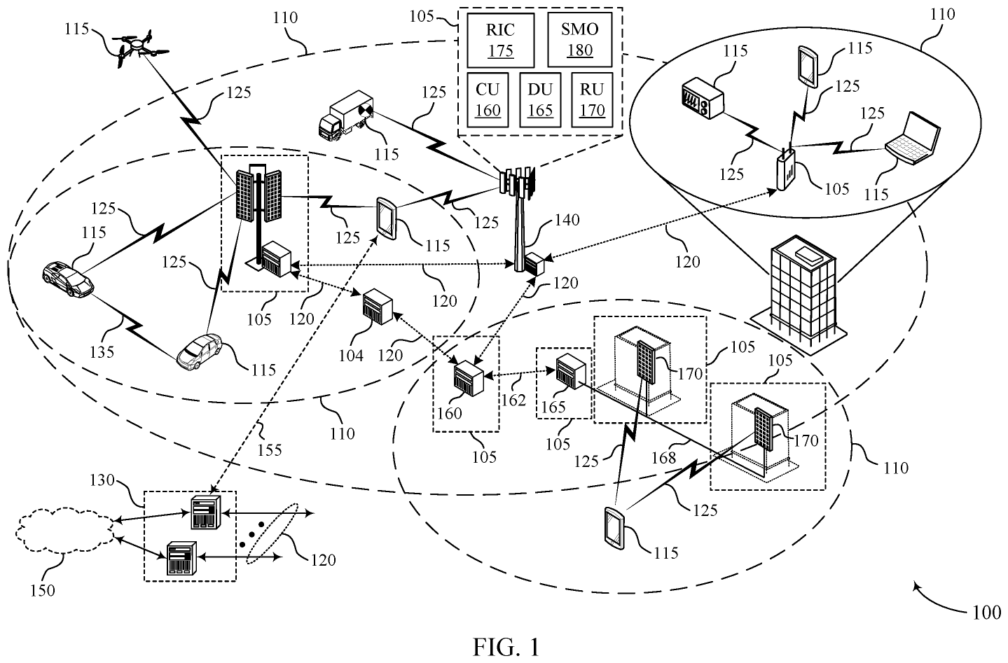

FIG. 1 shows an example of a wireless communications system 100 that supports differential CSI reporting for dynamic spatial and power adaptation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-NB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support differential CSI reporting for dynamic spatial and power adaptation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, the wireless communications system 100 may reduce energy consumption by operating in accordance with antenna spatial and power adaptation. For example, a network entity 105 may include a set of antennas used to communicate data traffic with one or more wireless devices (e.g., user equipment (UEs 115)). As such, the network entity 105 may dynamically update an antenna port configuration used for communication with a UE 115 based on a quantity of data traffic.

For instance, in accordance with SD adaptation, the network entity 105 may dynamically change the quantity or configuration of antenna ports in use. In accordance with PD adaptation, the network entity 105 may dynamically change the transmission power of the antennas. Both SD and PD adaptation may result in power reduction by dynamically configuring antenna settings based on data traffic. As such, the UE 115 may be configured to transmit CSI for each dynamic antenna configuration (e.g., multiple CSIs in a single CSI report). However, as the quantity of CSIs in a CSI report increases, the quantity of bits in the CSI report may increase. As such, dynamic antenna adaptation may increase a quantity of CSI resources, CSI reports, and CSI configuration to support multiple spatial patterns and power values.

To reduce the quantity of bits in the CSI report, the UE 115 may select one CSI in the CSI report as a baseline CSI and transmit the other CSIs as a differential CSI relative to the selected CSI. The UE 115 may determine the baseline CSI for a given CSI report according to the techniques described herein. For example, as part of a CSI reporting procedure, the UE 115 may receive or otherwise be assigned a set of resources (e.g., a set of CSI-RSs) to monitor for CSI reporting. Each received resource may be associated with a respective CQI, an RI, a resource ID value, a power offset value, or a combination thereof. In some examples, the UE 115 may select a baseline resource as the resource associated with the highest CQI, highest RI, or both. In some examples, the UE 115 may select a baseline resource as the resource associated with the highest or lowest resource ID value. In some examples, the UE 115 may select a baseline resource as the resource associated with the highest or lowest power offset value. As such, the CSI associated with the baseline resource may be the baseline CSI and the other CSIs may be differential CSIs relative to the baseline CSI. By transmitting a CSI report including differential CSIs, the UE 115 may reduce the quantity of bits included in the CSI report, which may reduce overhead associated with performing CSI reporting procedures with the network entity 105.

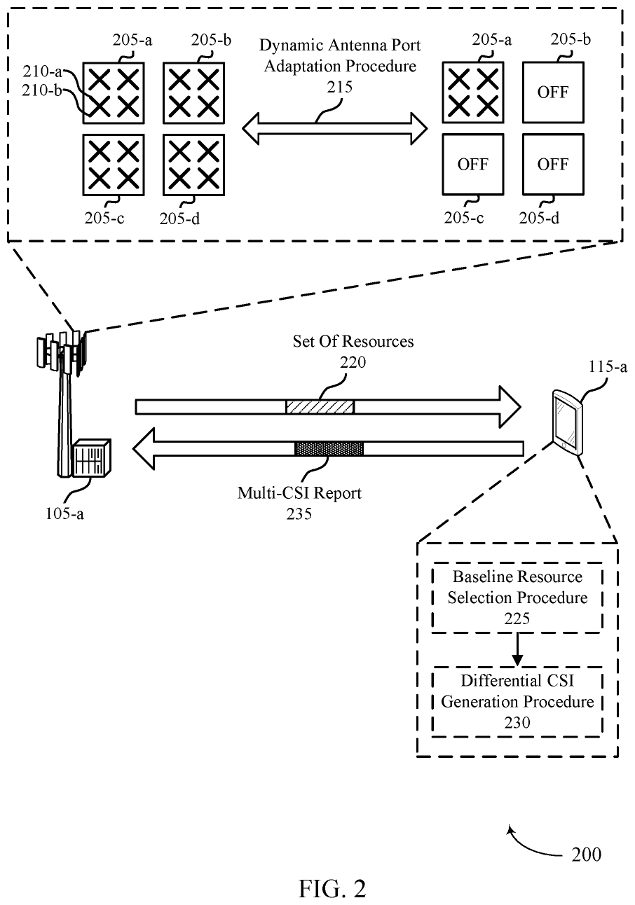

FIG. 2 shows an example of a wireless communications system 200 that supports differential CSI reporting for dynamic spatial and power adaptation in accordance with one or more aspects of the present disclosure. In some examples, the wireless communications system 200 may implement aspects of the wireless communications system 100. For example, the wireless communications system 200 may include a network entity 105-a and a UE 115-a, which may be examples of the corresponding devices described with reference to FIG. 1.

As illustrated in FIG. 2, the network entity 105-a may be configured with one or more antenna arrays 205 (e.g., antenna array 205-a, 205-b, 205-c, and 205-d), where each antenna array 205 may include a set of antennas elements. In some examples, the antenna arrays 205 may follow a 2D planar uniformly spaced antenna array model. Such a model may be represented by (M, N, P), where M may be a quantity of antenna elements with a same polarization in each column of an antenna array 205, N may be the quantity of columns in the antenna array 205, and P may be a quantity of polarization dimensions per antenna element. As such, each antenna array 205 may be represented by (2, 2, 2), such that each antenna array 205 may include four antenna elements evenly spaced in a 2×2 grid. Based on each antenna element having a politization dimension of two, each antenna element may correspond to two antenna ports 210. For instance, a first antenna element in antenna array 205-a may correspond to antenna port 210-a and antenna port 210-b, where antenna port 210-a and 210-b may be polarized with respect to one another. While FIG. 2 illustrates the network entity 105-a with four (2, 2, 2) antenna arrays 205, it is understood that the network entity 105-a may include any quantity of antenna arrays 205 that each correspond to any values of M, N and P. For instance, some other antenna array 205 configurations include, but are not limited to (8, 2, 2), (4, 2, 2), and (2, 1, 2).

As such, the network entity 105-a may use the antenna arrays 205 to communicate data traffic with one or more wireless devices, such as the UE 115-a. To determine an antenna configuration to use for communications, the UE 115-a and network entity 105-a may operate in accordance with a CSI reporting procedure. For instance, a given antenna configuration may correspond to a respective channel used to communicate data to the UE 115-a. As such, for a given antenna configuration, the network entity 105-a may transmit a CSI-RS. As such, the UE 115-a may receive the given CSI-RS corresponding to the given channel, and the UE 115-a may use the CSI-RS to measure quality of a channel quality and transmit a CSI report. In some cases, the network entity 105-a and UE 115-a may be configured with one or more CSI reporting configurations corresponding to different antenna configurations at the network entity 105-a.

In some cases, the network entity 105-a may reduce energy consumption by operating in accordance with dynamic antenna spatial and power adaptation. That is, the network entity 105-a may dynamically update an antenna configuration to adapt to wireless communications conditions between the UE 115-a and network entity 105-a. In some cases, the wireless communications conditions may include a quantity of data traffic, quality of channels, among other examples. As such, the network entity 105-a may operate in accordance with a dynamic antenna port adaptation procedure 215, which may adapt the antenna configuration in the SD, the PD, or both.

In examples of SD adaptation, the network entity 105-a may dynamically change the quantity or configuration of antenna ports 210 used for communications with the UE 115-a. As illustrated in FIG. 2, the network entity 105-a may enable or disable one or more antenna arrays 205 or one or more antenna elements of the antenna arrays 205. The network entity 105-a may determine to enable or disable different antenna arrays 205 or antenna elements based on the quantity of data communicated with the UE 115-a. For instance, if the quantity of data traffic with the UE 115-a falls below a configured threshold, the network entity 105-a may turn off one or more antenna arrays 205 or antenna elements. If the quantity of data traffic with the UE 115-a is above a configured threshold, the network entity 105-a may turn on one or more antenna arrays 205 or antenna elements. In a first type of SD adaptation (e.g., Type 1), the network entity 105-a may enable or disable all antenna elements associated with one or more antenna arrays 205, which may result in antenna port adaptation. In a second type of SD adaptation (e.g., Type 2), the network entity 105-a may enable or disable a subset of antenna elements associated with one or more antenna arrays 205 which may result in adaptation of values of power offset between a synchronization signal block (SSB) and CSI-RS for a given channel.

In examples of PD adaptation, the network entity 105-a may dynamically change the transmission power or power spectral density (PSD) of downlink signals and channels. That is, the network entity 105-a may dynamically change the power of one or more antenna elements or one or more antenna arrays 205. For instance, if channel quality with the UE 115-a falls above a configured threshold, the network entity 105-a may reduce the transmission power of one or more antenna arrays 205 or antenna elements. If the channel quality with the UE 115-a is below a configured threshold, the network entity 105-a may increase the transmission power on one or more antenna arrays 205 or antenna elements. In some cases, PD adaptation may result in adaptation of values of power offset between CSI-RS and physical downlink control channel (PDSCH) transmissions for a given channel.

In some cases, however, the dynamic antenna port adaptation procedure 215 may be associated with an increase in CSI-RS resources, CSI reports, and CSI configurations to support the multiple spatial patterns and power values. For instance, in accordance with dynamic PD adaptation, the UE 115-a may receive multiple CSI-RSs for a single antenna configuration, where each CSI-RS may correspond to a different power offset value of the single antenna configuration. As such, the UE 115-a may be configured to provide a CSI for each power offset, such that there may be multiple CSIs included in a single report. In some examples, a given CSI may be an example of a CQI, a RI, or a PMI. As such, the information of a CSI (e.g., the CQI, RI, PMI, or a combination thereof) may be carried by a set of bits. As the quantity of CSIs increases for a single CSI report, the quantity of bits may increase, which may increase communication overhead associated with performing a CSI reporting procedure.

To reduce the total quantity of bits across multiple CSIs, the UE 115-a may determine one CSI of the set of CSIs for a given CSI report as a baseline CSI. For example, as part of a CSI reporting procedure, the UE 115-a may receive a set of resources 220 (e.g., a set of CSI-RSs). As such, the UE 115-a may generate a CSI for each resource of the set of resources 220. The UE 115-a may select one CSI to serve as baseline CSI where the baseline CSI may serve as a reference CSI, such that the other CSIs in the given CSI report may be differential CSIs relative to the baseline CSI. In one example, the UE 115-a may receive the set of resources 220, which may be associated with 10 different power offsets for an antenna configuration, and generate a corresponding PMI for each of the 10 different power offsets. In such an example, the UE 115-a may select a first PMI as the baseline CSI and select the other PMIs to be differential CSIs. In some cases, the baseline CSI may correspond to a first quantity of bits and each of the differential CSIs may correspond to a second quantity of bits that may be less than the first quantity. As such, transmitting a multi-CSI report 235 that includes a baseline CSI and a set of differential CSIs relative to the baseline CSI, may reduce the overhead associated with CSI reporting.

In some cases, the UE 115-a may select the baseline CSI based on performing a baseline resource selection procedure 225. For instance, as part of the baseline resource selection procedure 225, the UE 115-a may select a resource form the set of resources 220 as a baseline resource, where the CSI associated with the baseline resource may be the baseline CSI.

In some cases, the UE 115-a may select the baseline resource based on the associated CQI, rank, or both. For example, the UE 115-a may select the baseline resource as the resource corresponding to the highest CQI out of the set of resources 220. If multiple resources of the set of resources 220 have a same highest CQI, the UE 115-a may additionally use the rank of each resource from the set of resources 220 to select the baseline resource. For instance, of the resources with the highest CQI, the resource with the highest rank may be selected as the baseline resource. Additionally or alternatively, the UE 115-a may select the baseline resource as the resource corresponding to the highest rank out of the set of resources 220. If multiple resources of the set of resources 220 have a same highest rank, the UE 115-a may additionally use the CQI of each resource from the set of resources 220 to select the baseline resource. For instance, of the resources with the highest rank, the resource with the highest CQI may be selected as the baseline resource.

In some examples, the resources of the set of resources 220 may be associated with CSI-RS codebooks. If the codebook has a rank higher than four, the codebook may be associated with multiple (e.g., two) codewords. In such cases, a first codeword may be associated with a first indicator (e.g., a first CQI) and a second codeword may be associated with a second indicator (e.g., a second CQI). As such, if the selected baseline resource is associated with a codebook with multiple codewords (e.g., a codebook with a rank higher than four), the UE 115-a may determine whether to select the indicator associated with first codeword or the second codeword as the baseline CSI. In some examples, the network entity 105-a may configure the UE 115-a (e.g., via RRC signaling) to select the first indicator associated with the first codeword as the baseline CSI. In some other examples, the network entity 105-a may configure the UE 115-a (e.g., via radio RRC signaling) to select between the first indicator associated with first codeword and the second indictor associated with the second codeword. As such, the UE 115-a may select the first indictor or the second indicator as the baseline CSI for each codebook configuration. Additionally, the UE 115-a may indicate in the multi-CSI report 235 which of the first indicator and the second indictor the UE 115-a selected as the baseline CSI.

In some cases, the UE 115-a may select the baseline resource based on the associated CSI-RS resource ID, power offset value, or both. For example, the UE 115-a may select the baseline resource from the set of resources 220 based on CSI-RS resource ID. In some examples, the UE 115-a selects the baseline resource as the resource associated with the lowest CSI-RS resource ID out of the set of resources 220. In some examples, the UE 115-a selects the baseline resource as the resource associated with the highest CSI-RS resource ID out of the set of resources 220. In one example, the set of resources 220 may include six non-zero power (NZP) CSI-RS resources for a channel measurement (e.g., {R0, R1, R2, R3, R4, R5}). As such, the UE 115-a may select the baseline resource as the resource with the lowest CSI-RS resource ID (e.g., R0) or select the baseline resource as the resource with the highest CSI-RS resource ID (e.g., R5). Additionally or alternatively, the UE 115-a may select the baseline resource as the resource from the set of resources 220 based on power offset value. In some examples, the UE 115-a selects the baseline resource as the resource associated with the lowest power offset value out of the set of resources 220. In some examples, the UE 115-a selects the baseline resource as the resource associated with the highest power offset value out of the set of resources 220.

Based on performing the baseline resource selection procedure 225, the UE may identify the baseline CSI (e.g., the CSI associated with the selected baseline resource). As such, the UE may perform a differential CSI generation procedure 230 to generate one or more differential CSIs corresponding to the other resources of the set of resource 220. The UE may include the set of bits associated baseline CSI and the differential CSIs that are relative to the baseline CSI in the multi-CSI report 235.

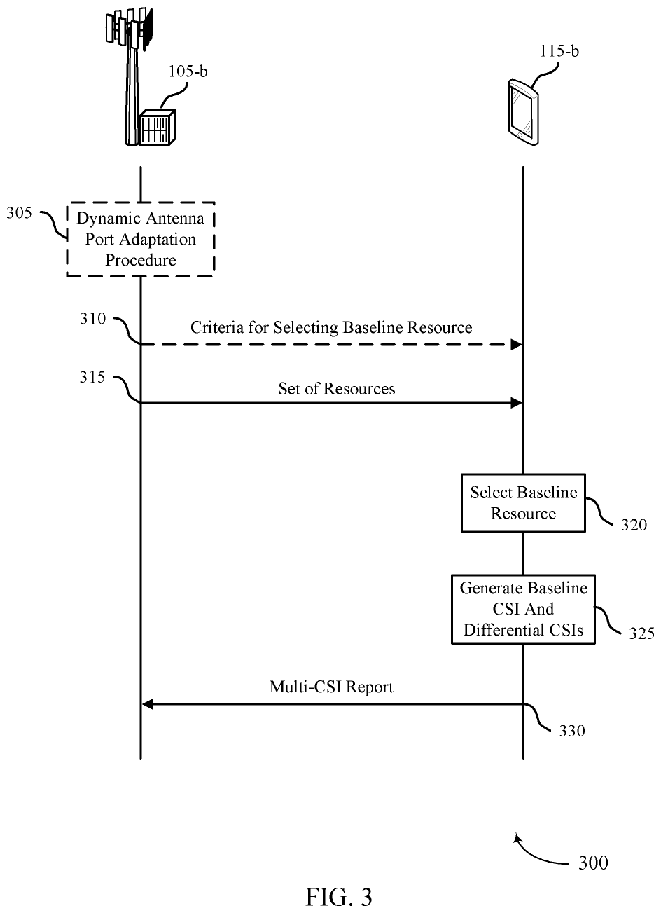

FIG. 3 shows an example of a process flow 300 that supports differential CSI reporting for dynamic spatial and power adaptation in accordance with one or more aspects of the present disclosure. In some examples, process flow 300 may implement aspects of wireless communications system 100 and wireless communications system 200. Process flow 300 includes a UE 115-b and a network entity 105-b which may be respective examples of a 115 and a network entity 105, as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 300 shows processes between a single UE 115 and a single network entity 105, it should be understood that these processes may occur between any quantity of network devices and network device types.

At 305, the network entity 105-b may perform a dynamic antenna port adaptation procedure (e.g., dynamic antenna port adaptation procedure 215, with reference to FIG. 2). As described with reference to FIG. 2, the network entity 105-b may utilize SD adaptation and PD adaptation of one or more antenna elements or antenna arrays to reduce power consumption at the network entity 105-b.

At 310, the network entity 105-b may transmit to the UE 115-b control signaling (e.g., RRC signaling) including an indication of a criteria to use for selecting a baseline resource. In some examples, the baseline resource may be used in performing a CSI reporting procedure, where multiple CSIs are included in a single CSI report. Additionally, or alternatively, the criteria for selecting the baseline resource may be stored at the UE 115-b (e.g., pre-configured at the UE 115-b).

At 315, the UE 115-b may receive a set of resources in accordance with a CSI reporting procedure.

At 320, the UE 115-b may select a first resource from the set of resources as a baseline resource based on the criteria for the set of resources.

In some examples, the criteria for the set of resources is a CQI value. As such, the UE 115-b may measure a respective CQI for each resource of the set of resources, where selecting the first resource as the baseline resource may be based on the first resource being associated with a highest CQI value out of the set of resources. In some cases, the first resource and one or more other resources of the set of resources may each have the highest CQI value out of the set of resources. In such cases, selecting the first resource as the baseline resource may be additionally based on the first resource being associated with a highest RI value out of the set of resources. In some examples, the UE 115-b may receive indication of a RI for each resource of the set of resources (e.g., as part of receiving the set of resources at 315).

In some examples, the criteria for the set of resources is an RI value. As such, the UE 115-b may receive a respective RI for each resource of the set of resources (e.g., as part of receiving the set of resources at 315). As such, the UE may select the first resource as the baseline resource based on the first resource being associated with a highest RI value out of the set of resources. In some cases, the first resource and one or more other resources of the set of resources may each have the highest RI value out of the set of resources. In such cases, selecting the first resource as the baseline resource may be additionally based on the UE 115-a measuring a respective CQI for each resource of the set of resources. As such, first resource may be selected as the baseline resource based on the first resource being associated with a highest CQI value out of the set of resources.

In some cases, the baseline resource corresponds to a codebook that has a rank greater than four, the codebook being associated with a first codeword associated with a first indicator and a second codeword associated with a second indicator. In some examples, the UE 115-b may select the first indicator as the baseline indicator based on the first indicator being associated with the first codeword and based on the first resource satisfying the criteria for the set of resources. In some other examples, the UE 115-b may select the first indicator or the second indicator as the baseline indicator irrespective of association with the first codeword and the second codeword and based on the first resource satisfying the criteria for the set of resources. In such examples, the UE 115-b may transmit, as part of the multi-CSI report, an indication of whether the UE 115-b selected the first indicator or the second indicator as the baseline indicator.

In some examples, each resource of the set of resources may be associated with a respective resource ID, and the criteria for the set of resources may be based on a resource ID value. As such, the UE 115-b may select the first resource as the baseline resource based on the first resource being associated with a highest resource ID value out of the set of resources or based on the first resource being associated with a lowest resource ID value out of the set of resources.

In some examples, each resource of the set of resources may be associated with a respective power offset value, and the criteria for the set of resources may be based on a power offset value. As such, the UE 115-b may select the first resource as the baseline resource based on the first resource being associated with a highest power offset value out of the set of resources or based on the first resource being associated with a lowest power offset value out of the set of resources.

At 325, the UE 115-b may generate a baseline indicator associated with the baseline resource and respective differential indicators for each other resource of the set of resources, where the respective differential indicators are relative to the baseline indicator. In some examples, the baseline indicator is a CQI, and the respective differential indicators are each a respective differential CQI. In some examples, the baseline indicator is a RI, and the respective differential indicators are each a respective differential RI. In some examples, the baseline indicator is a PMI, and the respective differential indicators are each a respective differential PMI.

At 330, the UE 115-b may transmit in accordance with the CSI reporting procedure, a multi-CSI report that includes the baseline indicator associated with the baseline resource and the respective differential indicators for each other resource of the set of resources.

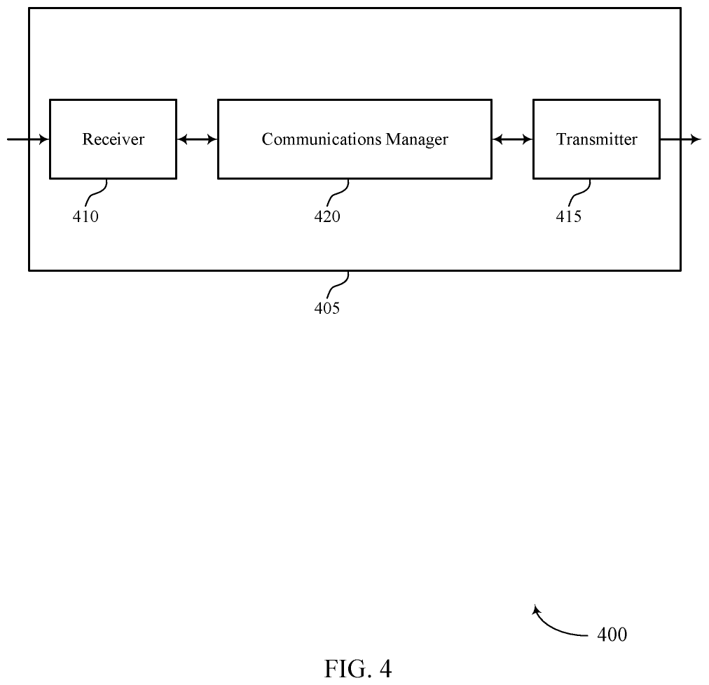

FIG. 4 shows a block diagram 400 of a device 405 that supports differential CSI reporting for dynamic spatial and power adaptation in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to differential CSI reporting for dynamic spatial and power adaptation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to differential CSI reporting for dynamic spatial and power adaptation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of differential CSI reporting for dynamic spatial and power adaptation as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a set of resources in accordance with a CSI reporting procedure. The communications manager 420 is capable of, configured to, or operable to support a means for selecting a first resource from the set of resources as a baseline resource based on a criteria for the set of resources. The communications manager 420 is capable of, configured to, or operable to support a means for transmitting, in accordance with the CSI reporting procedure, a CSI report including a baseline indicator associated with the baseline resource and respective differential indicators for each other resource of the set of resources, where the respective differential indicators are relative to the baseline indicator.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for decreasing overhead associated with performing CSI reporting procedures which may result in reduced processing, reduced power consumption, and more efficient utilization of communication resources.

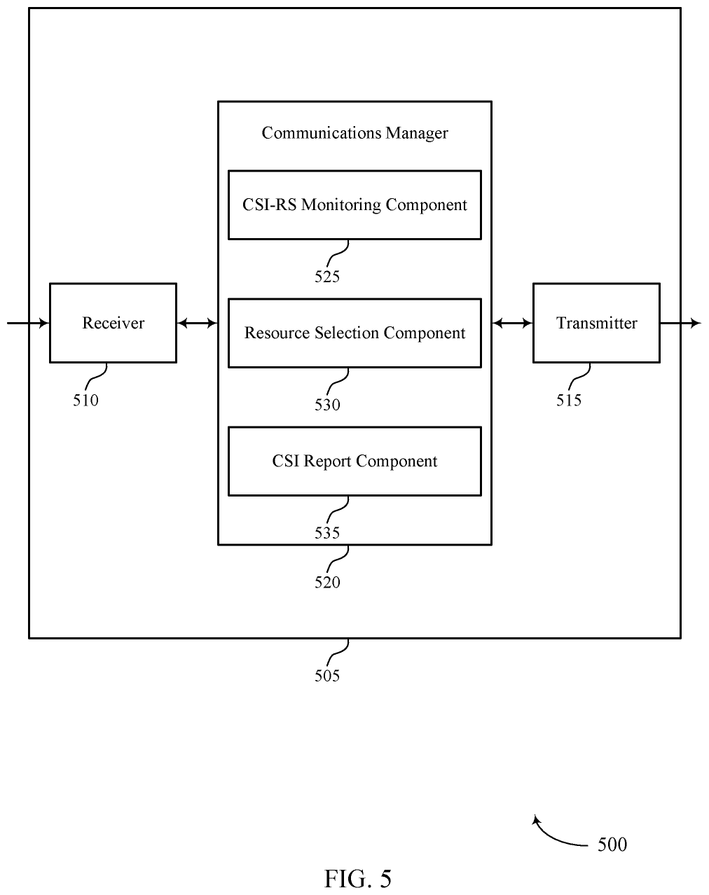

FIG. 5 shows a block diagram 500 of a device 505 that supports differential CSI reporting for dynamic spatial and power adaptation in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to differential CSI reporting for dynamic spatial and power adaptation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to differential CSI reporting for dynamic spatial and power adaptation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of differential CSI reporting for dynamic spatial and power adaptation as described herein. For example, the communications manager 520 may include a CSI-RS monitoring component 525, a resource selection component 530, a CSI report component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The CSI-RS monitoring component 525 is capable of, configured to, or operable to support a means for receiving a set of resources in accordance with a CSI reporting procedure. The resource selection component 530 is capable of, configured to, or operable to support a means for selecting a first resource from the set of resources as a baseline resource based on a criteria for the set of resources. The CSI report component 535 is capable of, configured to, or operable to support a means for transmitting, in accordance with the CSI reporting procedure, a CSI report including a baseline indicator associated with the baseline resource and respective differential indicators for each other resource of the set of resources, where the respective differential indicators are relative to the baseline indicator.

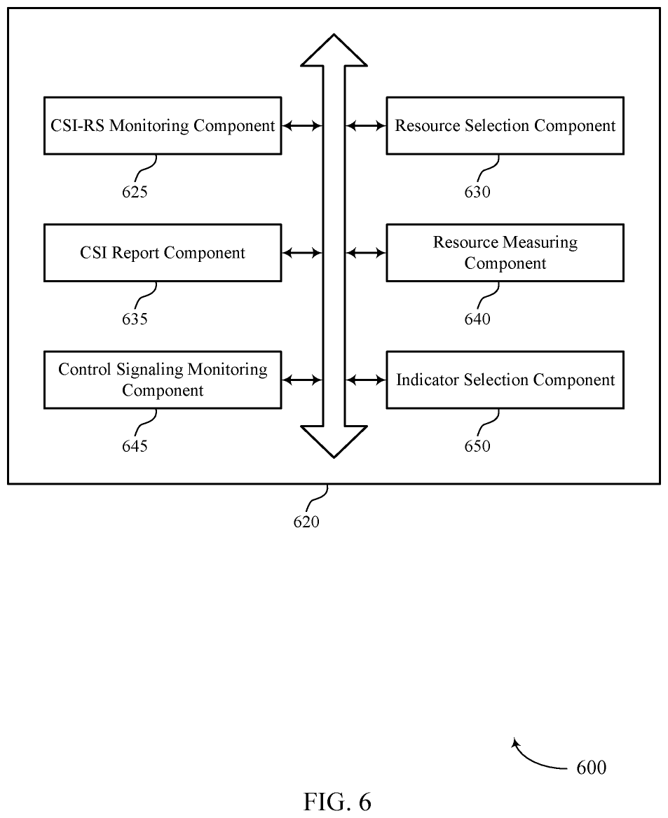

FIG. 6 shows a block diagram 600 of a communications manager 620 that supports differential CSI reporting for dynamic spatial and power adaptation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of differential CSI reporting for dynamic spatial and power adaptation as described herein. For example, the communications manager 620 may include a CSI-RS monitoring component 625, a resource selection component 630, a CSI report component 635, a resource measuring component 640, a control signaling monitoring component 645, an indicator selection component 650, or any combination thereof. Each of these components may communicate, directly or indirectly, with one another (e.g., via one or more buses).

The communications manager 620 may support wireless communications in accordance with examples as disclosed herein. The CSI-RS monitoring component 625 is capable of, configured to, or operable to support a means for receiving a set of resources in accordance with a CSI reporting procedure. The resource selection component 630 is capable of, configured to, or operable to support a means for selecting a first resource from the set of resources as a baseline resource based on a criteria for the set of resources. The CSI report component 635 is capable of, configured to, or operable to support a means for transmitting, in accordance with the CSI reporting procedure, a CSI report including a baseline indicator associated with the baseline resource and respective differential indicators for each other resource of the set of resources, where the respective differential indicators are relative to the baseline indicator.

In some examples, the criteria for the set of resources is a CQI value, and the resource measuring component 640 is capable of, configured to, or operable to support a means for measuring a respective CQI for each resource of the set of resources, where selecting the first resource as the baseline resource is based on the first resource being associated with a highest CQI value out of the set of resources.

In some examples, the first resource and one or more other resources of the set of resources each have the highest CQI value out of the set of resources, and the CSI-RS monitoring component 625 is capable of, configured to, or operable to support a means for receiving a respective RI for each resource of the set of resources, where selecting the first resource as the baseline resource is further based on the first resource being associated with a highest RI value out of the set of resources.

In some examples, the criteria for the set of resources is a RI value, and the CSI-RS monitoring component 625 is capable of, configured to, or operable to support a means for receiving a respective RI for each resource of the set of resources, where selecting the first resource as the baseline resource is based on the first resource being associated with a highest RI value out of the set of resources.

In some examples, the first resource and one or more other resources of the set of resources each have the highest RI value out of the set of resources, and the resource measuring component 640 is capable of, configured to, or operable to support a means for measuring a respective CQI for each resource of the set of resources, where selecting the first resource as the baseline resource is further based on the first resource being associated with a highest CQI value out of the set of resources.

In some examples, the baseline resource corresponds to a codebook that has a rank greater than four, the codebook being associated with a first codeword associated with a first indicator and a second codeword associated with a second indicator.

In some examples, to support selecting the first resource as the baseline resource, the indicator selection component 650 is capable of, configured to, or operable to support a means for selecting the first indicator as the baseline indicator based on the first indicator being associated with the first codeword and based on the first resource satisfying the criteria for the set of resources.

In some examples, to support selecting the first resource as the baseline resource, the indicator selection component 650 is capable of, configured to, or operable to support a means for selecting the first indicator or the second indicator as the baseline indicator based on irrespective of association with the first codeword and the second codeword and based on the first resource satisfying the criteria for the set of resources. In some examples, to support selecting the first resource as the baseline resource, the CSI report component 635 is capable of, configured to, or operable to support a means for transmitting, as part of the CSI report, an indication of whether the UE selected the first indicator or the second indicator as the baseline indicator.

In some examples, each resource of the set of resources is associated with a respective power offset value, and the criteria for the set of resources is based on a power offset value.

In some examples, selecting the first resource as the baseline resource is further based on the first resource being associated with a highest power offset value out of the set of resources.

In some examples, selecting the first resource as the baseline resource is further based on the first resource being associated with a lowest power offset value out of the set of resources.

In some examples, the control signaling monitoring component 645 is capable of, configured to, or operable to support a means for receiving control signaling including an indication of the criteria for the set of resources to use for selecting the baseline resource.

In some examples, the criteria for the set of resources to use for selecting the baseline resource is stored at the UE.

In some examples, the CSI report component 635 is capable of, configured to, or operable to support a means for transmitting, as part of the CSI report, an indication of the criteria for the set of resources used for selecting the baseline resource.

In some examples, the baseline indicator is a CQI and the respective differential indicators are each a respective differential CQI, the baseline indicator is a RI and the respective differential indicators are each a respective differential RI, or the baseline indicator is a PMI and the respective differential indicators are each a respective differential PMI.

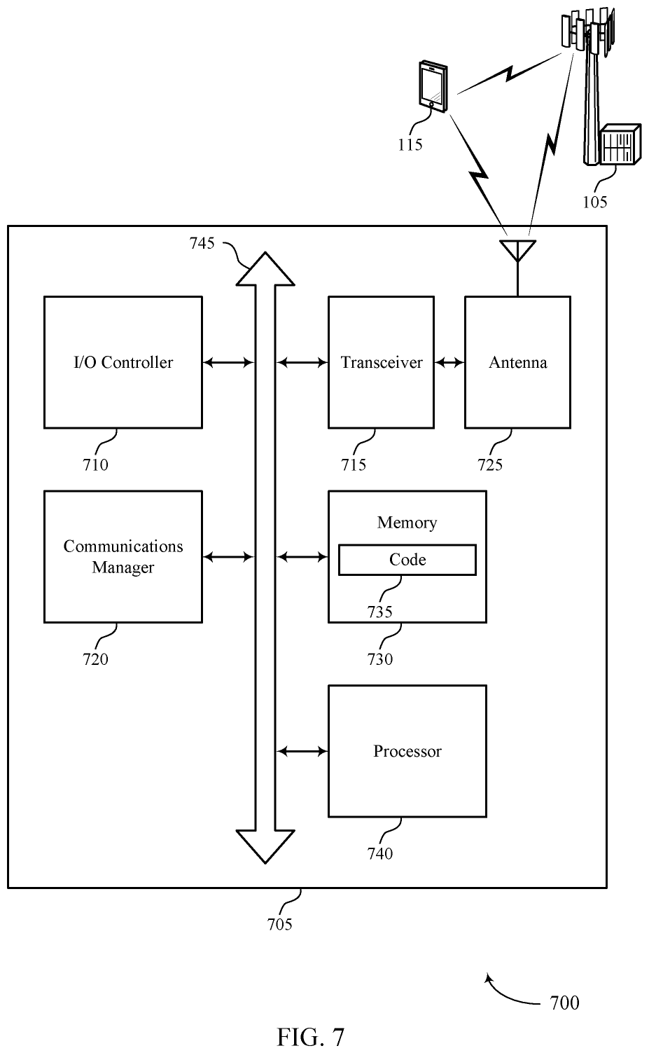

FIG. 7 shows a diagram of a system 700 including a device 705 that supports differential CSI reporting for dynamic spatial and power adaptation in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting differential CSI reporting for dynamic spatial and power adaptation). For example, the device 705 or a component of the device 705 may include a processor 740 and memory 730 coupled with or to the processor 740, the processor 740 and memory 730 configured to perform various functions described herein.

The communications manager 720 may support wireless communications in accordance with examples as disclosed herein. For example, the communications manager 720 is capable of, configured to, or operable to support a means for receiving a set of resources in accordance with a CSI reporting procedure. The communications manager 720 is capable of, configured to, or operable to support a means for selecting a first resource from the set of resources as a baseline resource based on a criteria for the set of resources. The communications manager 720 is capable of, configured to, or operable to support a means for transmitting, in accordance with the CSI reporting procedure, a CSI report including a baseline indicator associated with the baseline resource and respective differential indicators for each other resource of the set of resources, where the respective differential indicators are relative to the baseline indicator.

By including or configuring the communications manager 720 in accordance with examples as described herein, the device 705 may support techniques for decreasing overhead associated with performing CSI reporting procedures which may result in improved communication reliability, reduced latency, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of differential CSI reporting for dynamic spatial and power adaptation as described herein, or the processor 740 and the memory 730 may be otherwise configured to perform or support such operations.

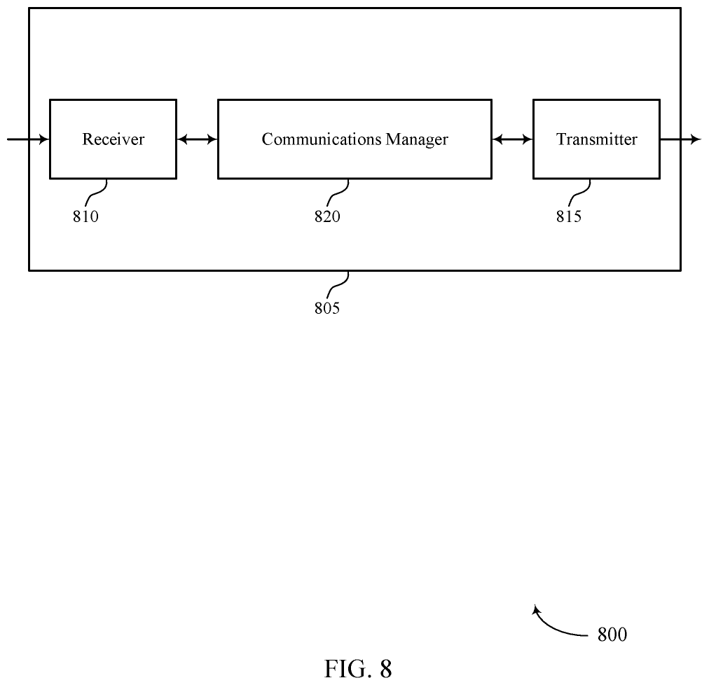

FIG. 8 shows a block diagram 800 of a device 805 that supports differential CSI reporting for dynamic spatial and power adaptation in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of differential CSI reporting for dynamic spatial and power adaptation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a set of resources in accordance with a CSI reporting procedure for a dynamic antenna configuration of the network entity. The communications manager 820 is capable of, configured to, or operable to support a means for receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for decreasing overhead associated with performing CSI reporting procedures which may result in reduced processing, reduced power consumption, and more efficient utilization of communication resources.

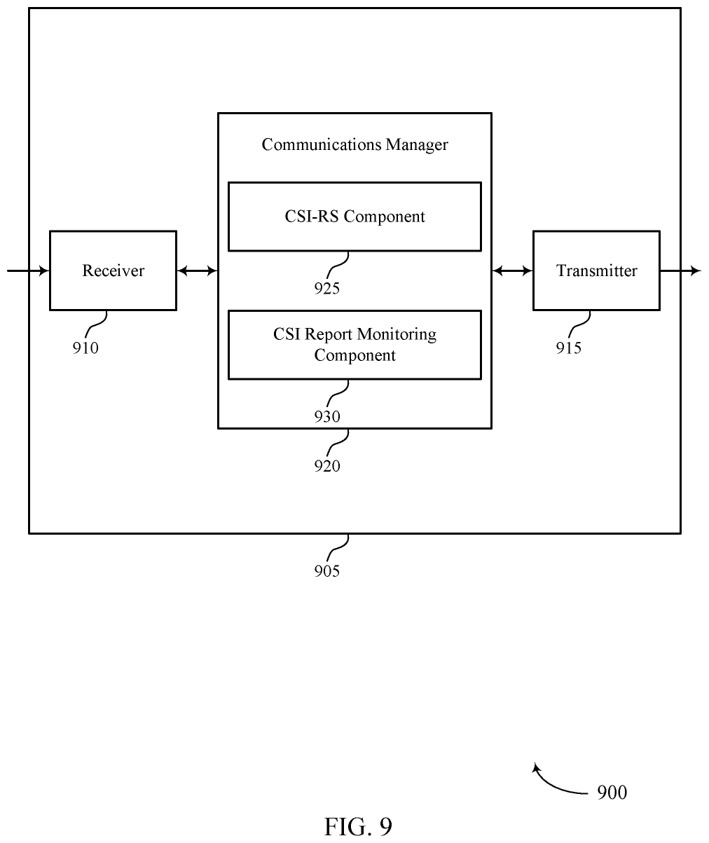

FIG. 9 shows a block diagram 900 of a device 905 that supports differential CSI reporting for dynamic spatial and power adaptation in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of differential CSI reporting for dynamic spatial and power adaptation as described herein. For example, the communications manager 920 may include a CSI-RS component 925 a CSI report monitoring component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The CSI-RS component 925 is capable of, configured to, or operable to support a means for transmitting a set of resources in accordance with a CSI reporting procedure for a dynamic antenna configuration of the network entity. The CSI report monitoring component 930 is capable of, configured to, or operable to support a means for receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

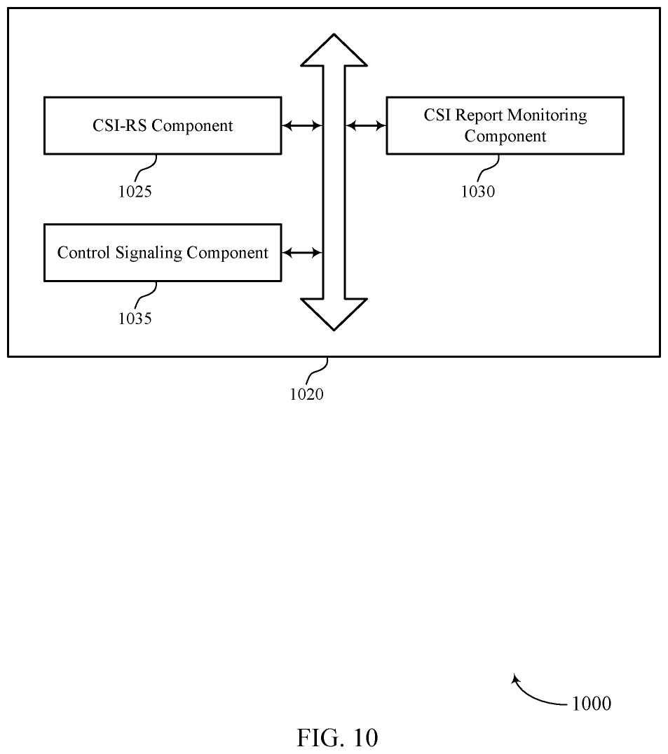

FIG. 10 shows a block diagram 1000 of a communications manager 1020 that supports differential CSI reporting for dynamic spatial and power adaptation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of differential CSI reporting for dynamic spatial and power adaptation as described herein. For example, the communications manager 1020 may include a CSI-RS component 1025, a CSI report monitoring component 1030, a control signaling component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The CSI-RS component 1025 is capable of, configured to, or operable to support a means for transmitting a set of resources in accordance with a CSI reporting procedure for a dynamic antenna configuration of the network entity. The CSI report monitoring component 1030 is capable of, configured to, or operable to support a means for receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

In some examples, the control signaling component 1035 is capable of, configured to, or operable to support a means for transmitting control signaling including an indication of a criteria for the set of resources for a UE to use selecting the baseline resource.

In some examples, to support criteria, the control signaling component 1035 is capable of, configured to, or operable to support a means for indicating for the UE to select the baseline resource as a resource from the set of resources being associated with a highest CQI value out of the set of resources, a highest RI value out of the set of resources, or both.

In some examples, to support criteria, the control signaling component 1035 is capable of, configured to, or operable to support a means for indicating for the UE to select the baseline resource as a resource from the set of resources being associated with a highest or lowest resource ID value out of the set of resources.

In some examples, to support criteria, the control signaling component 1035 is capable of, configured to, or operable to support a means for indicating for the UE to select the baseline resource as a resource from the set of resources being associated with a highest or lowest power offset value out of the set of resources.

In some examples, the CSI report monitoring component 1030 is capable of, configured to, or operable to support a means for receiving, as part of the CSI report, an indication of the criteria for the set of resources used by the UE for selecting the baseline resource.

In some examples, the baseline resource corresponds to a codebook that has a rank greater than four, and the CSI report monitoring component 1030 is capable of, configured to, or operable to support a means for receiving, as part of the CSI report, an indication of whether the first indicator or the second indicator is the baseline indicator.

In some examples, the baseline indicator is a CQI and the respective differential indicators are each a respective differential CQI, the baseline indicator is a RI and the respective differential indicators are each a respective differential RI, or the baseline indicator is a PMI and the respective differential indicators are each a respective differential PMI.

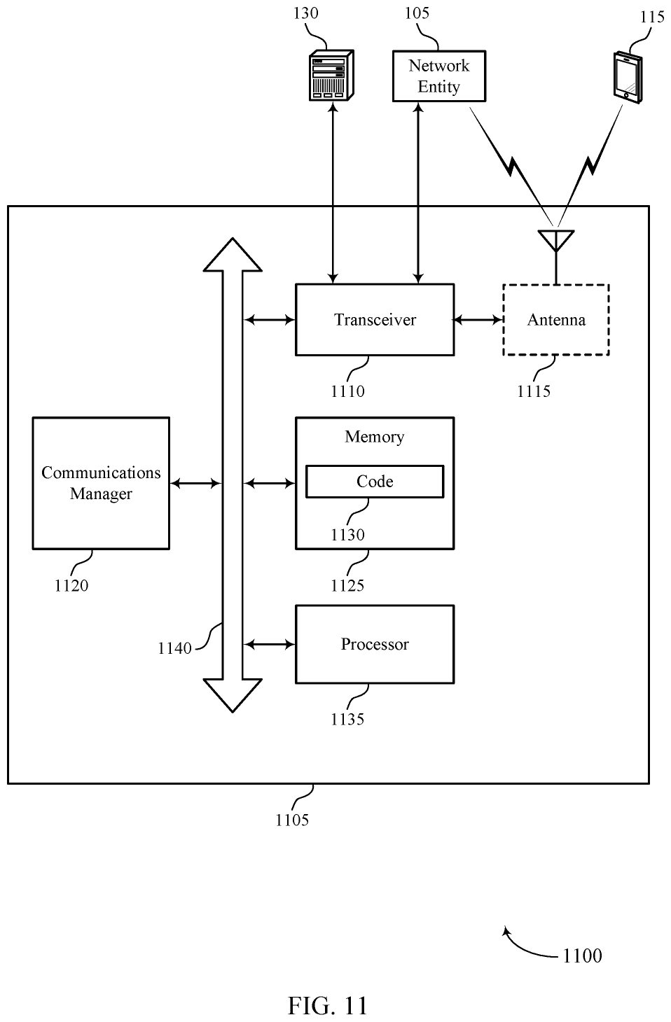

FIG. 11 shows a diagram of a system 1100 including a device 1105 that supports differential CSI reporting for dynamic spatial and power adaptation in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting differential CSI reporting for dynamic spatial and power adaptation). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting a set of resources in accordance with a CSI reporting procedure for a dynamic antenna configuration of the network entity. The communications manager 1120 is capable of, configured to, or operable to support a means for receiving, in accordance with the CSI reporting procedure, a CSI report including a baseline indicator associated with a baseline resource of the set of resources and respective differential indicators for each other resource of the set of resources, where the respective differential indicators are relative to the baseline indicator.

By including or configuring the communications manager 1120 in accordance with examples as described herein, the device 1105 may support techniques for decreasing overhead associated with performing CSI reporting procedures which may result in improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of differential CSI reporting for dynamic spatial and power adaptation as described herein, or the processor 1135 and the memory 1125 may be otherwise configured to perform or support such operations.

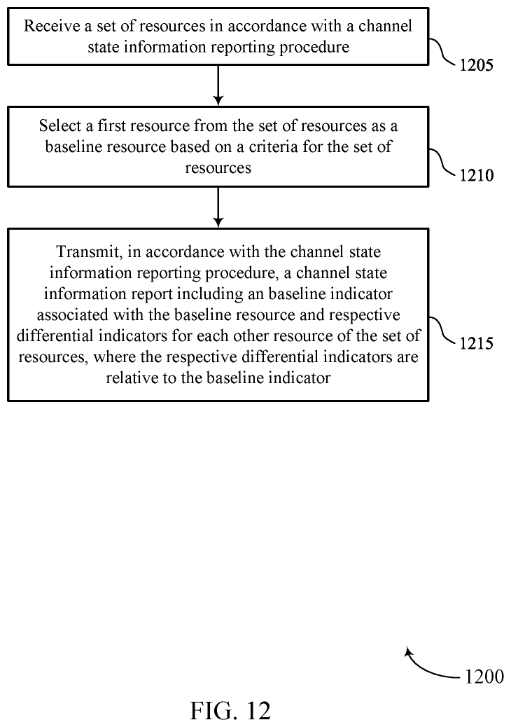

FIG. 12 shows a flowchart illustrating a method 1200 that supports differential CSI reporting for dynamic spatial and power adaptation in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a set of resources in accordance with a CSI reporting procedure. The operations of block 1205 may be performed in accordance with examples as disclosed herein. In some examples, aspects of the operations of 1205 may be performed by a CSI-RS monitoring component 625 as described with reference to FIG. 6.

At 1210, the method may include selecting a first resource from the set of resources as a baseline resource based on a criteria for the set of resources. The operations of block 1210 may be performed in accordance with examples as disclosed herein. In some examples, aspects of the operations of 1210 may be performed by a resource selection component 630 as described with reference to FIG. 6.

At 1215, the method may include transmitting, in accordance with the CSI reporting procedure, a CSI report including a baseline indicator associated with the baseline resource and respective differential indicators for each other resource of the set of resources, where the respective differential indicators are relative to the baseline indicator. The operations of block 1215 may be performed in accordance with examples as disclosed herein. In some examples, aspects of the operations of 1215 may be performed by a CSI report component 635 as described with reference to FIG. 6.

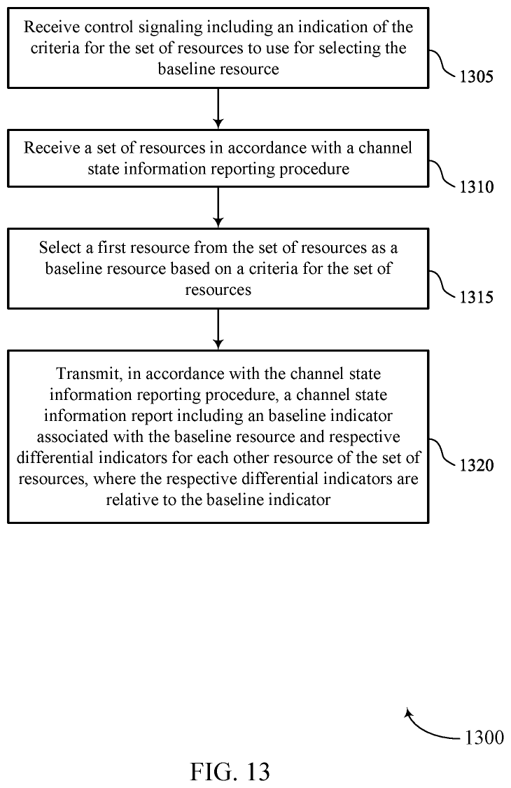

FIG. 13 shows a flowchart illustrating a method 1300 that supports differential CSI reporting for dynamic spatial and power adaptation in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling including an indication of the criteria for the set of resources to use for selecting the baseline resource. The operations of block 1305 may be performed in accordance with examples as disclosed herein. In some examples, aspects of the operations of 1305 may be performed by a control signaling monitoring component 645 as described with reference to FIG. 6.

At 1310, the method may include receiving a set of resources in accordance with a CSI reporting procedure. The operations of block 1310 may be performed in accordance with examples as disclosed herein. In some examples, aspects of the operations of 1310 may be performed by a CSI-RS monitoring component 625 as described with reference to FIG. 6.

At 1315, the method may include selecting a first resource from the set of resources as a baseline resource based on a criteria for the set of resources. The operations of block 1315 may be performed in accordance with examples as disclosed herein. In some examples, aspects of the operations of 1315 may be performed by a resource selection component 630 as described with reference to FIG. 6.

At 1320, the method may include transmitting, in accordance with the CSI reporting procedure, a CSI report including a baseline indicator associated with the baseline resource and respective differential indicators for each other resource of the set of resources, where the respective differential indicators are relative to the baseline indicator. The operations of block 1320 may be performed in accordance with examples as disclosed herein. In some examples, aspects of the operations of 1320 may be performed by a CSI report component 635 as described with reference to FIG. 6.

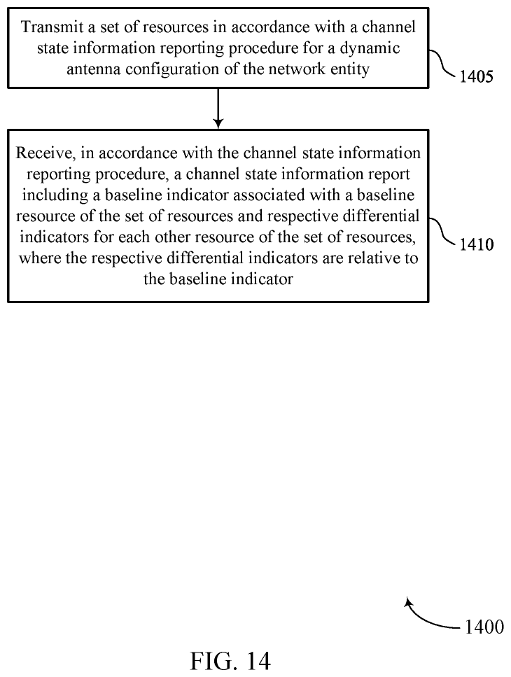

FIG. 14 shows a flowchart illustrating a method 1400 that supports differential CSI reporting for dynamic spatial and power adaptation in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a set of resources in accordance with a CSI reporting procedure for a dynamic antenna configuration of the network entity. The operations of block 1405 may be performed in accordance with examples as disclosed herein. In some examples, aspects of the operations of 1405 may be performed by a CSI-RS component 1025 as described with reference to FIG. 10.

At 1410, the method may include receiving, in accordance with the CSI reporting procedure, a CSI report including a baseline indicator associated with a baseline resource of the set of resources and respective differential indicators for each other resource of the set of resources, where the respective differential indicators are relative to the baseline indicator. The operations of block 1410 may be performed in accordance with examples as disclosed herein. In some examples, aspects of the operations of 1410 may be performed by a CSI report monitoring component 1030 as described with reference to FIG. 10.

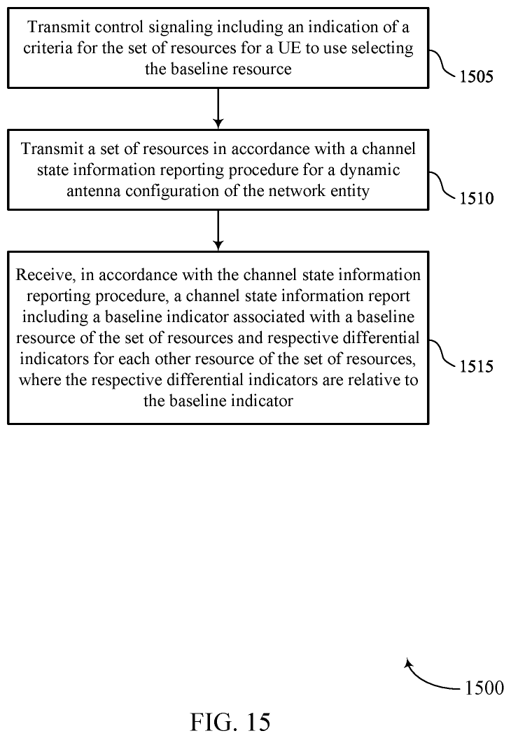

FIG. 15 shows a flowchart illustrating a method 1500 that supports differential CSI reporting for dynamic spatial and power adaptation in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling including an indication of a criteria for the set of resources for a UE to use selecting the baseline resource. The operations of block 1505 may be performed in accordance with examples as disclosed herein. In some examples, aspects of the operations of 1505 may be performed by a control signaling component 1035 as described with reference to FIG. 10.

At 1510, the method may include transmitting a set of resources in accordance with a CSI reporting procedure for a dynamic antenna configuration of the network entity. The operations of block 1510 may be performed in accordance with examples as disclosed herein. In some examples, aspects of the operations of 1510 may be performed by a CSI-RS component 1025 as described with reference to FIG. 10.

At 1515, the method may include receiving, in accordance with the CSI reporting procedure, a CSI report including a baseline indicator associated with a baseline resource of the set of resources and respective differential indicators for each other resource of the set of resources, where the respective differential indicators are relative to the baseline indicator. The operations of block 1515 may be performed in accordance with examples as disclosed herein. In some examples, aspects of the operations of 1515 may be performed by a CSI report monitoring component 1030 as described with reference to FIG. 10.

The following provides an overview of aspects of the present disclosure:
Aspect 1: A method for wireless communications, at a UE, comprising: receiving a set of resources in accordance with a CSI reporting procedure; selecting a first resource from the set of resources as a baseline resource based at least in part on a criteria for the set of resources; and transmitting, in accordance with the CSI reporting procedure, a CSI report comprising an baseline indicator associated with the baseline resource and respective differential indicators for each other resource of the set of resources, wherein the respective differential indicators are relative to the baseline indicator.
Aspect 2: The method of aspect 1, wherein the criteria for the set of resources is a CQI value, the method further comprising: measuring a respective CQI for each resource of the set of resources, wherein selecting the first resource as the baseline resource is based at least in part on the first resource being associated with a highest CQI value out of the set of resources.
Aspect 3: The method of aspect 2, wherein the first resource and one or more other resources of the set of resources each have the highest CQI value out of the set of resources, the method further comprising: receiving a respective RI for each resource of the set of resources, wherein selecting the first resource as the baseline resource is further based at least in part on the first resource being associated with a highest RI value out of the set of resources.
Aspect 4: The method of any of aspects 1 through 3, wherein the criteria for the set of resources is a RI value, the method further comprising: receiving a respective RI for each resource of the set of resources, wherein selecting the first resource as the baseline resource is based at least in part on the first resource being associated with a highest RI value out of the set of resources.
Aspect 5: The method of aspect 4, wherein the first resource and one or more other resources of the set of resources each have the highest RI value out of the set of resources, the method further comprising: measuring a respective CQI for each resource of the set of resources, wherein selecting the first resource as the baseline resource is further based at least in part on the first resource being associated with a highest CQI value out of the set of resources.
Aspect 6: The method of any of aspects 1 through 5, wherein the baseline resource corresponds to a codebook that has a rank greater than four, the codebook being associated with a first codeword associated with a first indicator and a second codeword associated with a second indicator.
Aspect 7: The method of aspect 6, wherein selecting the first resource as the baseline resource comprises: selecting the first indicator as the baseline indicator based at least in part on the first indicator being associated with the first codeword and based at least in part on the first resource satisfying the criteria for the set of resources.
Aspect 8: The method of any of aspects 6 through 7, wherein selecting the first resource as the baseline resource comprises: selecting the first indicator or the second indicator as the baseline indicator based at least in part on irrespective of association with the first codeword and the second codeword and based at least in part on the first resource satisfying the criteria for the set of resources; and transmitting, as part of the CSI report, an indication of whether the UE selected the first indicator or the second indicator as the baseline indicator.
Aspect 9: The method of any of aspects 1 through 8, wherein each resource of the set of resources is associated with a respective power offset value, and the criteria for the set of resources is based at least in part on a power offset value.
Aspect 10: The method of aspect 9, wherein selecting the first resource as the baseline resource is further based at least in part on the first resource being associated with a highest power offset value out of the set of resources.
Aspect 11: The method of any of aspects 9 through 10, wherein selecting the first resource as the baseline resource is further based at least in part on the first resource being associated with a lowest power offset value out of the set of resources.
Aspect 12: The method of any of aspects 1 through 11, further comprising: receiving control signaling comprising an indication of the criteria for the set of resources to use for selecting the baseline resource.
Aspect 13: The method of any of aspects 1 through 12, wherein the criteria for the set of resources to use for selecting the baseline resource is stored at the UE.
Aspect 14: The method of any of aspects 1 through 13, further comprising: transmitting, as part of the CSI report, an indication of the criteria for the set of resources used for selecting the baseline resource.
Aspect 15: The method of any of aspects 1 through 14, wherein the baseline indicator is a CQI and the respective differential indicators are each a respective differential CQI, the baseline indicator is a RI and the respective differential indicators are each a respective differential RI, or the baseline indicator is a PMI and the respective differential indicators are each a respective differential PMI.
Aspect 16: A method for wireless communications, at a network entity, comprising: transmitting a set of resources in accordance with a CSI reporting procedure for a dynamic antenna configuration of the network entity; and receiving, in accordance with the CSI reporting procedure, a CSI report comprising a baseline indicator associated with a baseline resource of the set of resources and respective differential indicators for each other resource of the set of resources, wherein the respective differential indicators are relative to the baseline indicator.
Aspect 17: The method of aspect 16, further comprising: transmitting control signaling comprising an indication of a criteria for the set of resources for a UE to use selecting the baseline resource.
Aspect 18: The method of aspect 17, wherein the criteria comprises: indicating for the UE to select the baseline resource as a resource from the set of resources being associated with a highest CQI value out of the set of resources, a highest RI value out of the set of resources, or both.
Aspect 19: The method of any of aspects 17 through 18, wherein the criteria comprises: indicating for the UE to select the baseline resource as a resource from the set of resources being associated with a highest or lowest resource ID value out of the set of resources.
Aspect 20: The method of any of aspects 17 through 19, wherein the criteria comprises: indicating for the UE to select the baseline resource as a resource from the set of resources being associated with a highest or lowest power offset value out of the set of resources.
Aspect 21: The method of any of aspects 17 through 20, further comprising: receiving, as part of the CSI report, an indication of the criteria for the set of resources used by the UE for selecting the baseline resource.
Aspect 22: The method of any of aspects 16 through 21, wherein the baseline resource corresponds to a codebook that has a rank greater than four, the codebook being associated with a first codeword associated with a first indicator and a second codeword associated with a second indicator, the method further comprising: receiving, as part of the CSI report, an indication of whether the first indicator or the second indicator is the baseline indicator.
Aspect 23: The method of any of aspects 16 through 22, wherein the baseline indicator is a CQI and the respective differential indicators are each a respective differential CQI, the baseline indicator is a RI and the respective differential indicators are each a respective differential RI, or the baseline indicator is a PMI and the respective differential indicators are each a respective differential PMI.
Aspect 24: A UE for wireless communications, comprising one or more memories storing processor-executable code, and one or more processors coupled with the one or more memories and operable to execute the code to cause the UE to perform a method of any of aspects 1 through 15.
Aspect 25: A UE for wireless communications, comprising at least one means for performing a method of any of aspects 1 through 15.
Aspect 26: A non-transitory computer-readable medium storing code for wireless communications, the code comprising instructions executable by one or more processors to perform a method of any of aspects 1 through 15.
Aspect 27: A network entity for wireless communications, comprising one or more memories storing processor-executable code, and one or more processors coupled with the one or more memories and operable to execute the code to cause the network entity to perform a method of any of aspects 16 through 23.
Aspect 28: A network entity for wireless communications, comprising at least one means for performing a method of any of aspects 16 through 23.
Aspect 29: A non-transitory computer-readable medium storing code for wireless communications, the code comprising instructions executable by one or more processors to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a set of resources in accordance with a channel state information reporting procedure;
select a first resource from the set of resources as a baseline resource based at least in part on a criteria for the set of resources; and
transmit, in accordance with the channel state information reporting procedure, a channel state information report comprising a baseline indicator associated with the baseline resource and respective differential indicators for each other resource of the set of resources, wherein the respective differential indicators are relative to the baseline indicator.

2. The UE of claim 1, wherein the criteria for the set of resources is a channel quality indicator value, and the one or more processors are individually or collectively further operable to execute the code to cause the UE to:
measure a respective channel quality indicator for each resource of the set of resources, wherein selecting the first resource as the baseline resource is based at least in part on the first resource being associated with a highest channel quality indicator value out of the set of resources.

3. The UE of claim 2, wherein the first resource and one or more other resources of the set of resources each have the highest channel quality indicator value out of the set of resources, and the one or more processors are individually or collectively further operable to execute the code to cause the UE to:
receive a respective rank indicator for each resource of the set of resources, wherein selecting the first resource as the baseline resource is further based at least in part on the first resource being associated with a highest rank indicator value out of the set of resources.

4. The UE of claim 1, wherein the criteria for the set of resources is a rank indicator value, and the one or more processors are individually or collectively further operable to execute the code to cause the UE to:
receive a respective rank indicator for each resource of the set of resources, wherein selecting the first resource as the baseline resource is based at least in part on the first resource being associated with a highest rank indicator value out of the set of resources.

5. The UE of claim 4, wherein the first resource and one or more other resources of the set of resources each have the highest rank indicator value out of the set of resources, and the one or more processors are individually or collectively further operable to execute the code to cause the UE to:
measure a respective channel quality indicator for each resource of the set of resources, wherein selecting the first resource as the baseline resource is further based at least in part on the first resource being associated with a highest channel quality indicator value out of the set of resources.

6. The UE of claim 1, wherein the baseline resource corresponds to a codebook that has a rank greater than four, the codebook being associated with a first codeword associated with a first indicator and a second codeword associated with a second indicator.

7. The UE of claim 6, wherein the one or more processors are individually or collectively further operable to execute the code to cause the UE to:
select the first indicator as the baseline indicator based at least in part on the first indicator being associated with the first codeword and based at least in part on the first resource satisfying the criteria for the set of resources.

8. The UE of claim 6, wherein the one or more processors are individually or collectively further operable to execute the code to cause the UE to:
select the first indicator or the second indicator as the baseline indicator based at least in part on irrespective of association with the first codeword and the second codeword and based at least in part on the first resource satisfying the criteria for the set of resources; and
transmit, as part of the channel state information report, an indication of whether the UE selected the first indicator or the second indicator as the baseline indicator.

9. The UE of claim 1, wherein each resource of the set of resources is associated with a respective power offset value, and the criteria for the set of resources is based at least in part on a power offset value.

10. The UE of claim 9, wherein selecting the first resource as the baseline resource is further based at least in part on the first resource being associated with a highest power offset value out of the set of resources.

11. The UE of claim 9, wherein selecting the first resource as the baseline resource is further based at least in part on the first resource being associated with a lowest power offset value out of the set of resources.

12. The UE of claim 1, wherein the one or more processors are individually or collectively further operable to execute the code to cause the UE to:
receive control signaling comprising an indication of the criteria for the set of resources to use for selecting the baseline resource.

13. The UE of claim 1, wherein the criteria for the set of resources to use for selecting the baseline resource is stored at the UE.

14. The UE of claim 1, wherein the one or more processors are individually or collectively further operable to execute the code to cause the UE to:
transmit, as part of the channel state information report, an indication of the criteria for the set of resources used for selecting the baseline resource.

15. The UE of claim 1, wherein:
the baseline indicator is a channel quality indicator and the respective differential indicators are each a respective differential channel quality indicator,
the baseline indicator is a rank indicator and the respective differential indicators are each a respective differential rank indicator, or
the baseline indicator is a pre-coding matrix indicator and the respective differential indicators are each a respective differential pre-coding matrix indicator.

16. A network entity, comprising:
one or more memories storing processor-executable code; and
one or more processors coupled with the one or more memories and individually or collectively operable to execute the code to cause the network entity to:
transmit a set of resources in accordance with a channel state information reporting procedure for a dynamic antenna configuration of the network entity; and
receive, in accordance with the channel state information reporting procedure, a channel state information report comprising a baseline indicator associated with a baseline resource of the set of resources and respective differential indicators for each other resource of the set of resources, wherein the respective differential indicators are relative to the baseline indicator.

17. The network entity of claim 16, wherein the one or more processors are individually or collectively further operable to execute the code to cause the network entity to:
transmit control signaling comprising an indication of a criteria for the set of resources for a user equipment (UE) to use selecting the baseline resource.

18. The network entity of claim 17, wherein the one or more processors are individually or collectively further operable to execute the code to cause the network entity to:
indicate for the UE to select the baseline resource as a resource from the set of resources being associated with a highest channel quality indicator value out of the set of resources, a highest rank indicator value out of the set of resources, or both.

19. The network entity of claim 17, wherein the one or more processors are individually or collectively further operable to execute the code to cause the network entity to:
indicate for the UE to select the baseline resource as a resource from the set of resources being associated with a highest or lowest resource ID value out of the set of resources.

20. The network entity of claim 17, wherein the one or more processors are individually or collectively further operable to execute the code to cause the network entity to:
indicate for the UE to select the baseline resource as a resource from the set of resources being associated with a highest or lowest power offset value out of the set of resources.

21. The network entity of claim 17, wherein the one or more processors are individually or collectively further operable to execute the code to cause the network entity to:
receive, as part of the channel state information report, an indication of the criteria for the set of resources used by the UE for selecting the baseline resource.

22. The network entity of claim 16, wherein the baseline resource corresponds to a codebook that has a rank greater than four, the codebook being associated with a first codeword associated with a first indicator and a second codeword associated with a second indicator, and the one or more processors are individually or collectively further operable to execute the code to cause the network entity to:
receive, as part of the channel state information report, an indication of whether the first indicator or the second indicator is the baseline indicator.

23. The network entity of claim 16, wherein:
the baseline indicator is a channel quality indicator and the respective differential indicators are each a respective differential channel quality indicator,
the baseline indicator is a rank indicator and the respective differential indicators are each a respective differential rank indicator, or
the baseline indicator is a pre-coding matrix indicator and the respective differential indicators are each a respective differential pre-coding matrix indicator.

24. A method for wireless communications, at a user equipment (UE), comprising:
receiving a set of resources in accordance with a channel state information reporting procedure;
selecting a first resource from the set of resources as a baseline resource based at least in part on a criteria for the set of resources; and
transmitting, in accordance with the channel state information reporting procedure, a channel state information report comprising a baseline indicator associated with the baseline resource and respective differential indicators for each other resource of the set of resources, wherein the respective differential indicators are relative to the baseline indicator.

25. The method of claim 24, wherein the criteria for the set of resources is a channel quality indicator value, the method further comprising:
measuring a respective channel quality indicator for each resource of the set of resources, wherein selecting the first resource as the baseline resource is based at least in part on the first resource being associated with a highest channel quality indicator value out of the set of resources.

26. The method of claim 25, wherein the first resource and one or more other resources of the set of resources each have the highest channel quality indicator value out of the set of resources, the method further comprising:
receiving a respective rank indicator for each resource of the set of resources, wherein selecting the first resource as the baseline resource is further based at least in part on the first resource being associated with a highest rank indicator value out of the set of resources.

27. The method of claim 24, wherein the criteria for the set of resources is a rank indicator value, the method further comprising:
receiving a respective rank indicator for each resource of the set of resources, wherein selecting the first resource as the baseline resource is based at least in part on the first resource being associated with a highest rank indicator value out of the set of resources.

28. The method of claim 27, wherein the first resource and one or more other resources of the set of resources each have the highest rank indicator value out of the set of resources, the method further comprising:
measuring a respective channel quality indicator for each resource of the set of resources, wherein selecting the first resource as the baseline resource is further based at least in part on the first resource being associated with a highest channel quality indicator value out of the set of resources.

29. The method of claim 24, wherein the baseline resource corresponds to a codebook that has a rank greater than four, the codebook being associated with a first codeword associated with a first indicator and a second codeword associated with a second indicator.

30. A method for wireless communications, at a network entity, comprising:
transmitting a set of resources in accordance with a channel state information reporting procedure for a dynamic antenna configuration of the network entity; and
receiving, in accordance with the channel state information reporting procedure, a channel state information report comprising a baseline indicator associated with a baseline resource of the set of resources and respective differential indicators for each other resource of the set of resources, wherein the respective differential indicators are relative to the baseline indicator.
